(19) United States
(12) Patent Application Publication
(10) Pub. No.: US 2025/0245792 A1
(43) Pub. Date: Jul. 31, 2025

(54) IMAGE PROCESSING METHOD AND STORAGE MEDIUM

(71) Applicant: CANON KABUSHIKI KAISHA, Tokyo (JP)

(72) Inventors: MASAKAZU KOBAYASHI, Tokyo (JP); KENYA OGASAWARA, Tochigi (JP)

(21) Appl. No.: 19/035,251

(22) Filed: Jan. 23, 2025

(30) Foreign Application Priority Data
Jan. 26, 2024 (JP) 2024-010400
Mar. 26, 2024 (JP) 2024-050589
Jan. 17, 2025 (JP) 2025-007096

(51) Int. Cl. G06T 5/70; G06T 5/60

(52) U.S. Cl. CPC G06T 5/70; G06T 5/60; G06T 2207/20081; G06T 2207/20084

(57) ABSTRACT

An image processing method includes a step of generating an estimated image from an input image by using a plurality of machine learning models including a generative model and a non-generative model. In the step, the estimated image is generated by assigning different weights to output of the generative model and output of the non-generative model for each of a plurality of areas of the input image based on information regarding the input image.

### BACKGROUND

### Technical Field

The present disclosure relates to an image processing method using a machine learning model.

### Description of Related Art

There are a plurality of machine learning models that are different in terms of network structures and learning methods. A model that learns a probability distribution to generate various desired data and outputs data during inference according to that distribution is called a generative model. It is known that generative models demonstrate higher performance than conventional convolutional neural network (CNN) based machine learning models in regression tasks such as image deblurring, depth estimation, and upsampling. A method of sharpening image blur by using Jay Whang, Mauricio Delbracio, Hossein Talebi, Chitwan Saharia, Alexandros G. Dimakis, Peyman Milanfar, “Deblurring via Stochastic Refinement”, https://arxiv.org/abs/2112.02475 is disclosed.

### SUMMARY

An image processing method according to one aspect of the present disclosure includes a step of generating an estimated image from an input image by using a plurality of machine learning models including a generative model and a non-generative model. In the step, the estimated image is generated by assigning different weights to output of the generative model and output of the non-generative model for each of a plurality of areas of the input image based on information regarding the input image.

Further features of various embodiments of the disclosure will become apparent from the following description of embodiments with reference to the attached drawings.

### BRIEF DESCRIPTION OF THE DRAWINGS

FIG. 1 illustrates a point spread function at defocus distance in each example.

FIG. 2 is a block diagram of an image processing system in Examples 1 and 4.

FIG. 3 is an exterior diagram of the image processing system in Examples 1 and 4.

FIG. 4 is a flowchart of training of a non-generative model in Examples 1 to 3.

FIG. 5 is a flowchart of training of a generative model in Examples 1 to 3.

FIG. 6 is a flowchart illustrating model output generation in Example 1.

FIG. 7 illustrates a captured image and a defocus map in Example 1.

FIG. 8 illustrates area segmentation of the captured image in Example 1.

FIG. 9 explains the non-generative model in Example 1.

FIG. 10 explains the generative model in Example 1.

FIG. 11 is a block diagram of an image processing system in Example 2.

FIG. 12 is an exterior diagram of the image processing system in Example 2.

FIG. 13 is a flowchart illustrating model output generation in Example 2.

FIG. 14 explains a captured image and in-focus object information in Example 2.

FIG. 15 explains a depth map in Example 2.

FIG. 16 explains machine learning models in Example 2.

FIG. 17 is a block diagram of an image processing system in Example 3.

FIG. 18 is an exterior diagram of the image processing system in Example 3.

FIG. 19 explains machine learning models in Example 3.

FIG. 20 is a flowchart illustrating model output generation in Example 3.

FIG. 21 is a conceptual diagram of a first machine learning model.

FIG. 22 is a flowchart of the first machine learning model.

FIG. 23 is a conceptual diagram of a second machine learning model.

FIG. 24 is a flowchart of the second machine learning model.

FIG. 25 is a conceptual diagram of image processing in Example 4.

FIG. 26 is a flowchart of the image processing in Example 4.

FIG. 27 is a block diagram of an image processing system in Example 5.

FIG. 28 is a conceptual diagram of image processing in Example 6.

FIG. 29 is a flowchart of the image processing in Example 6.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

There are a plurality of machine learning models that are different in terms of network structures and learning methods. For example, a model that learns a probability distribution to generate various desired data and outputs data during inference according to that distribution is called a generative model. The generative model is learned (trained) so that the distribution of generated data matches the distribution of the learning data. Examples of typical generative models include a variational auto encoder (VAE), a generative adversarial network (GAN), a flow-based generative model, an autoregressive generative model, and a diffusion model. Each generative model will be explained.

A VAE consists of two main components: an encoder and a decoder. The encoder outputs two values, the mean u and variance σ, from which a latent variable Z is sampled. The latent variable Z is then reconstructed to the original dimension by the decoder. In a VAE, the distance between the distribution of generated data and the distribution of learning data is explicitly measured and minimized. To minimize this distance, the model is trained by maximizing the log likelihood of the learning data. However, in complex neural networks, directly calculating the log likelihood is challenging. Thus, a VAE aims to maximize the lower bound of the log likelihood, which is computationally feasible, to acquire the desired data distribution. Using a model learned in this way allows the generation of data that follows the target data distribution.

A GAN is a machine learning model consisting of a generator and a discriminator. The generator creates fake data x_{f}=G(z) based on input data z to the generator. The discriminator receives either real data xᵣ or fake data x_{f} as its input data (discriminator input data). The discriminator produces an output C(xⱼ) indicating whether the input data is fake. Here, j=r, f. Typically, the output C(xⱼ) is transformed using a function h, such as a sigmoid function σ, into a label D(xⱼ)=h(C(xⱼ)). During GAN training, the generator updates its weights (including biases) to make the discriminator identify fake data as real data, while the discriminator learns weights to correctly distinguish between real and fake data.

In a GAN, the generator and discriminator adversarially improve their accuracy through learning, enabling the generation of high-quality fake data with properties similar to real data. Unlike other generative models, a GAN does not explicitly bring the probability distributions of the learning data and generated data closer together; instead, they implicitly align the distributions through adversarial learning.

A diffusion model, like a VAE, learns a model by maximizing the lower bound of the log likelihood. The foundation of a diffusion model lies in a diffusion process, where noise is incrementally added to an image with the desired properties, eventually resulting in a completely noisy image, and a reverse diffusion process, where noise is incrementally removed to recover the image with the desired properties.

Here, the noise is Gaussian noise. Each stage is represented by a time step t, where t=0 corresponds to the state of the image with desired properties, and t=T corresponds to the completely noisy image. Since a diffusion model is inspired by thermodynamics, the term “time” is used for convenience, though it does not involve actual temporal changes, and t can alternatively be interpreted as a computation step or a noise intensity level.

The diffusion process, which adds noise to the image, is straightforward to execute. However, in the reverse diffusion process, simply subtracting Gaussian noise does not yield the desired image. Thus, a diffusion model uses neural networks to remove noise at each time step during the reverse diffusion process.

To maximize the lower bound of the log likelihood, the neural network is learned to minimize the error of the estimated noise. By repeatedly applying noise removal with the trained neural network from t=T, the noisy image at t=0 (data aligned with the target distribution) is obtained.

A flow-based generative model transforms the data distribution step-by-step to match the distribution of the learning data, enabling the generation of data that aligns with the target distribution.

To minimize the distance between the distributions of generated data and learning data, the model is learned to maximize the log likelihood of the learning data. In a flow-based generative model, complex transformations between distributions are represented as a series of simple transformations fᵢ, which are invertible, allowing direct calculation of the log likelihood. This enables the model to acquire the target data distribution by maximizing the computable log likelihood during training. Unlike a GAN and a VAE, a flow-based generative model allows both the transformation from data to latent variables and the generation of data from latent variables using a single model due to the invertibility of the transformations. A representative flow-based generative model is Glow, which applies 1×1 convolutions and affine transformations as simple transformations fᵢ.

An autoregressive generative model calculates the likelihood of data directly by accumulating the computationally feasible likelihoods for one dimension at a time, maximizing it through training. For example, in the case of images, the likelihood of the data is determined by sequentially calculating conditional probabilities for each pixel, starting from the top-left corner. PixelCNN, for instance, implements this by performing convolutions with kernels masked to reference only the pixels preceding each pixel.

While convolutional neural networks (CNNs) are sometimes used in internal processes of generative models, in this embodiment, a machine learning model that acquires a probability distribution through training to generate various desired data and outputs data based on that distribution during inference is referred to as a generative model. On the other hand, even if a machine learning model using CNN is employed, when it does not acquire a probability distribution for generating various desired data through training and outputs the average solution of the expected correct answers for the input data, it is referred to as a non-generative model in the present embodiment.

Although CNNs are used in internal processing of generative models in some cases, a model that learns the characteristics of a dataset and generates new data based on the characteristics among machine learning models where CNNs are used is referred to as a generative model in the present specification. On the other hand, a model that does not generate new data is referred to as a CNN (non-generative model). In particular, it is known that a diffusion model demonstrates higher performance than conventional CNNs in regression tasks such as deblurring, depth estimation, and upsampling. However, while generative models can generate high-resolution textures, it is known that the models potentially generate artificial structures that do not exist in the original object.

Thus, in the present embodiment, based on a defocus map, a generative model is used for shaping defocus blur on a non-focal plane, and a CNN is used for sharpening blur on a focal plane. With this configuration, it is possible to sharpen blur on a focal plane in a captured image and shape the shape of defocus blur on a non-focal plane into various shapes while preventing generation of artificial structures. Tasks processed by using a machine learning model are not limited thereto. Maps to be used are not limited to a defocus map. The maps may be, for example, a depth map, a segmentation map (semantic area segmentation map), information regarding a saturated area, and an optical performance map. Different weights are assigned to machine learning models based on the above-described information regarding a captured image.

A segmentation map is a map obtained by segmenting areas through class identification for each pixel on a captured image. For example, person areas and other areas (such as buildings, vehicles, and plants) are identified, blur sharpening is executed with a CNN for the person areas and with a generative model for the other areas. In the person areas, artificial structures are more likely to cause problems than in the other areas. Moreover, a person may be further segmented into skin areas and other areas (such as eyes and mouth), processing may be executed with a generative model in the skin areas, and processing may be executed with a CNN in the other areas. The determination method of machine learning models is not limited but the models may be freely determined in accordance with areas.

An optical performance map is a map calculated from the optical characteristics of an optical system used for image pickup of a captured image. In areas with low optical performance, adverse effects are likely to occur in blur sharpening. Thus, blur sharpening is executed with a CNN for high-performance areas and with a generative model low-performance areas.

Information regarding a saturated area includes a luminance saturation map and a saturation impact map. The luminance saturation map is a map indicating areas of luminance saturation in a captured image, and the saturation impact map is a map indicating the magnitude and extent of signal values spread by image-pickup degradation of objects in areas of luminance saturation in a captured image. Luminance-saturated areas may occur in an image due to the dynamic range of an image sensor and exposure during image pickup. In a case where blur sharpening is executed by using a machine learning model, adverse effects are likely to occur in luminance-saturated areas, where information regarding the structure of an object space cannot be acquired. Thus, blur sharpening is executed with a CNN in non-luminance-saturated areas and with a generative model in luminance-saturated areas.

As described above, by determining a machine learning model based on the segmentation map, the optical performance map, and the information regarding a saturated area, it is possible to perform processing that controls both the effect of blur sharpening and the occurrence of artificial structures.

In the following description, a stage where the weights of machine learning models are updated is referred to as a learning (training) phase, and a stage where blur sharpening is performed with machine learning models using weights obtained through the learning phase is referred to as an estimation phase.

### Example 1

Tasks using machine learning models in the present example are blur sharpening on a focal plane in a captured image and defocus blur shaping on a non-focal plane. A CNN is used for blur sharpening on the focal plane, and a diffusion model that is one of generative models is used for defocus blur shaping on the non-focal plane. The diffusion model will be described later. Blur to be sharpened is blur caused by aberrations and diffraction that occur through an optical system and blur caused by an optical lowpass filter. However, the same effects of the present disclosure can be obtained in cases where blur caused by pixel openings and shakes are sharpened.

Defocus blur shaping includes, for example, shaping of double-line blur into Gaussian blur or bokeh. Details of various defocus blur shapes will be described later. Examples of other shaping target defocus blur include defocus blur due to vignetting and ring-shaped defocus blur due to pupil obstruction in a catadioptric lens or the like. The shape of shaping target defocus blur is not limited and the shape of defocus blur after shaping is not limited. In the present example, a structure that does not exist in the original object is referred to as an artificial structure but is not an artificial structure because defocus blur shaping is processing of shaping the shapes of aberrations that occur through an optical system.

Difference from defocus blur addition performed in an image pickup apparatus (for example, smartphone) having a relatively wide-angle lens and a small sensor size will be described below. Images acquired by using a small image pickup apparatus with a wide-angle lens are unlikely to have blur. Thus, defocus blur is added to produce defocus blur desired by a user in some cases. However, defocus blur shaping performed in the present example shapes defocus blur of an object already having defocus blur into desired defocus blur. Thus, it is needed to apply defocus blur that satisfies the difference between already occurred defocus blur and desired defocus blur, which requires more advanced processing.

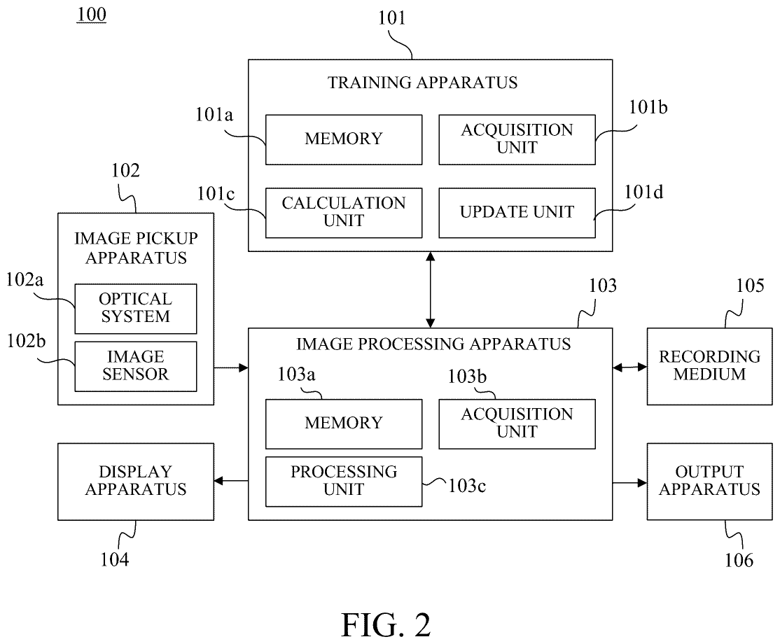

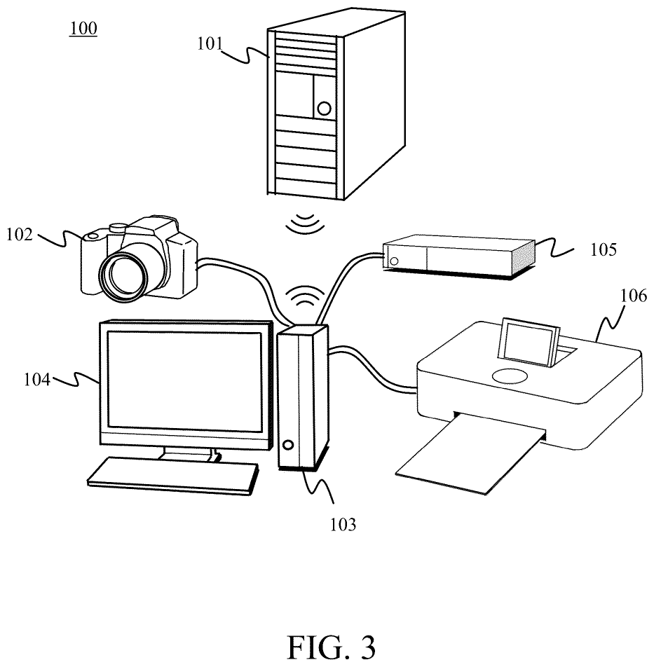

FIGS. 2 and 3 are a block diagram and an exterior diagram, respectively, of an image processing system 100 in the present example. The image processing system 100 includes a training apparatus 101 and an image processing apparatus 103 that are connected through a wired or wireless network. The image processing apparatus 103 is connected to an image pickup apparatus 102, a display apparatus 104, a recording medium 105, and an output apparatus 106 in a wired or wireless manner. A captured image obtained through image pickup of an object space by using the image pickup apparatus 102 is input to the image processing apparatus 103. Blur occurs to the captured image due to aberrations and diffraction through an optical system 102a in the image pickup apparatus 102 and an optical lowpass filter of an image sensor 102b, and attenuates object information. The image processing apparatus 103 executes blur sharpening on a focal plane and defocus blur shaping on a non-focal plane in the captured image by using machine learning models. The machine learning models are trained by the training apparatus 101, and the image processing apparatus 103 acquires information regarding the machine learning models from the training apparatus 101 and stores the information in a storage unit (memory) 103a in advance. The image processing apparatus 103 has a function to calculate a weighted mean of the outputs of a CNN and a generative model based on a defocus map in a boundary area between the focal plane and the non-focal plane. Training and estimation of machine learning models will be described later. Processed images are stored in the storage unit 103a or the recording medium 105 and output to the output apparatus 106 such as a printer as necessary. The captured image may be in grayscale or may have a plurality of color components. The captured image may also be an undeveloped RAW image or a developed image.

The image processing apparatus may be any apparatus having image processing functions in the present example and may be achieved in the form of an image pickup apparatus or a PC.

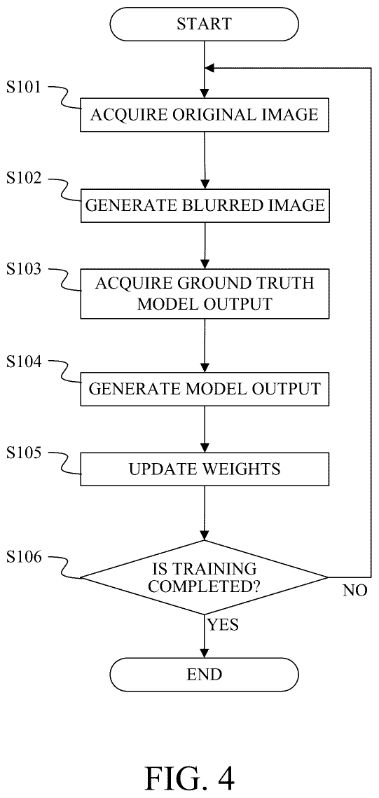

Training of a machine learning model that learns blur sharpening, which is executed by the training apparatus 101 will be described below with reference to FIG. 4. FIG. 4 is a flowchart of training of a machine learning model (CNN) in the present example. In the present example, a CNN is used as a machine learning model that learns blur sharpening. The training apparatus 101 includes a storage unit 101a, an acquisition unit 101b, a calculation unit 101c, and an update unit 101d, and each step below is executed by either member.

At step S101, the acquisition unit 101b acquires one or more original images from the storage unit 101a. Since the machine learning model is trained based on the original images, each original image is desirably an image having various frequency components (such as edges, gradations, and flat parts with different orientations and intensities). The original image may be a real-world image or a computer graphics (CG) image.

At step S102, the calculation unit 101c generates a blurred image by applying blur to the original image. The blurred image is an image to be input to the machine learning model during training and corresponds to a captured image in estimation. The applied blur is blur to be sharpened. In the present example, blur caused by aberrations and diffraction through the optical system 102a and by the optical lowpass filter of the image sensor 102b is applied. The shape of blur caused by aberrations and diffraction through the optical system 102a changes with image plane coordinates (image height and azimuth). The shape also changes with the magnification, aperture, and focus state of the optical system 102a. In a case where a machine learning model that sharpens all of these blurs is collectively trained, a plurality of blurred images may be generated by using a plurality of blurs caused by the optical system 102a. Noise that occurs in the image sensor 102b may be applied to the blurred images as necessary.

At step S103, the acquisition unit 101b acquires a ground truth model output. Since the task is blur sharpening, the ground truth model output is an image with smaller blur than that of the blurred image. In a case where the original image lacks high-frequency components, the ground truth model output may be a downscaled image of the original image. In this case, downscaling is also performed when the blurred image is generated at step S102. Step S103 may be executed at any timing after step S101 and before step S104.

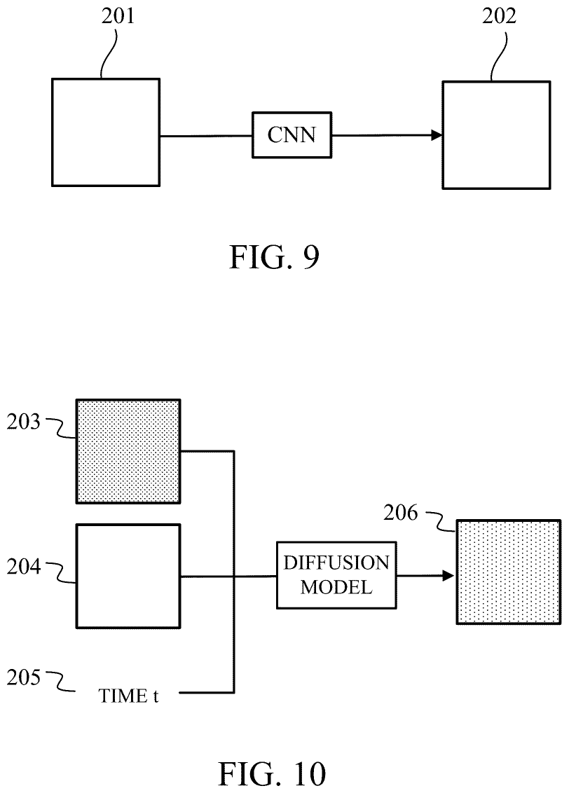

At step S104, the calculation unit 101c generates a model output based on the blurred image by using the machine learning model. In the present example, a machine learning model illustrated in FIG. 9 is used but the present disclosure is not limited thereto. This blurred image 201 is input to the machine learning model.

The machine learning model includes a plurality of layers, and in each layer, a linear combination of an input to the layer and weights is calculated. The initial values of the weights may be determined by random numbers or the like. In blur sharpening in the present example, the machine learning model is a CNN that uses, as the linear combination, the convolution of an input and a filter (the values of elements of the filter correspond to weights. In addition, the sum with biases may be included). However, the present disclosure is not limited thereto. In each layer, nonlinear conversion using an activation function such as a rectified linear unit (ReLU) or a sigmoid function is executed as necessary. The machine learning model may further include residual blocks and skip connections (also referred to as shortcut connections) as necessary. Through the plurality of layers, a model output 202 is generated.

At step S105, the update unit 101d updates the weights of the machine learning model based on an error function. In blur sharpening in the present example, the error function is the error between the model output 202 and the ground truth model output. The error is calculated by using mean squared error (MSE). However, the error function is not limited thereto. The weights may be updated by using backpropagation or the like. The error may be calculated for a residual component. In the case of the residual component, the error between difference components between the model output 202 and the blurred image 201 and between the ground truth model output and the blurred image 201 is used.

At step S106, the update unit 101d determines whether the training of the machine learning model is completed. The completion can be determined based on, for example, whether the number of iterations of the weight update has reached a predetermined number or whether the change amounts of the weights at the updating are smaller than a predetermined value. The update unit 101d ends the present flow when having determined the training is completed, or executes the processing at step S101 when having determined otherwise. After the present flow is ended, information regarding the configuration and weights of the machine learning model is stored in the storage unit 101a.

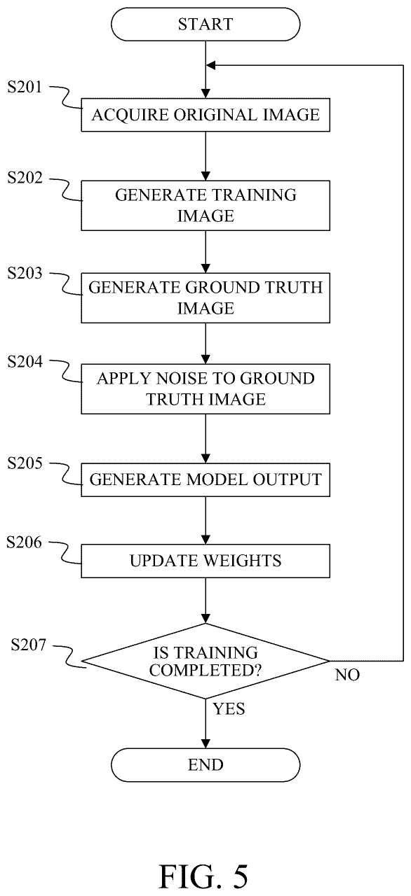

Training of a machine learning model that learns defocus blur shaping, which is executed by the training apparatus 101 will be described below with reference to FIG. 5. FIG. 5 is a flowchart of training of the machine learning model (diffusion model) in the present example. In the present example, a diffusion model is used as a generative model that learns defocus blur shaping. The training apparatus 101 includes the storage unit 101a, the acquisition unit 101b, the calculation unit 101c, and the update unit 101d, and each step below is executed by either member.

At step S201, the acquisition unit 101b acquires one or more original images from the storage unit 101a.

At step S202, the calculation unit 101c generates a training image and stores the training image in the storage unit 101a. The training image is an image obtained by performing image pickup simulation with shaping target defocus blur being applied to the original image. To handle any captured image, defocus blur corresponding to various defocus amounts may be applied. The application of defocus blur can be executed by convolving the original image with a PSF or taking the product of the frequency characteristics of the original image and an optical transfer function (OTF).

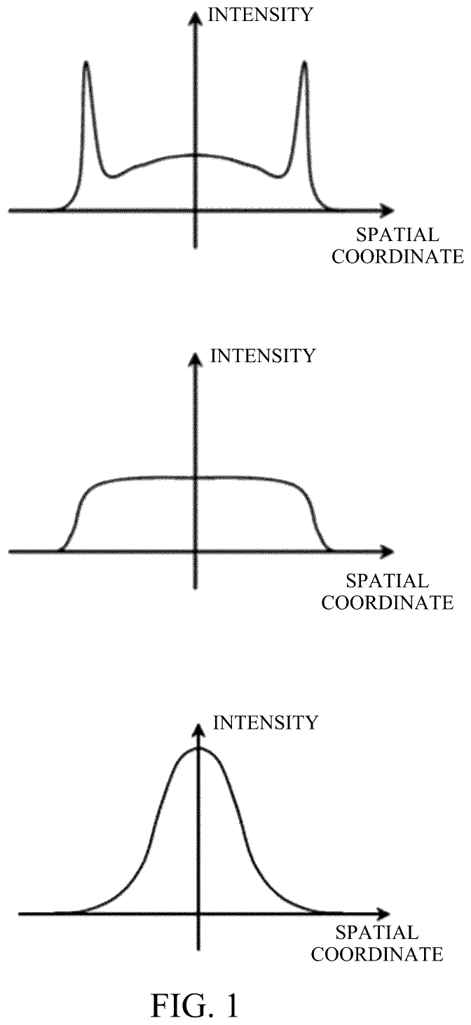

At step S203, the calculation unit 101c generates a ground truth image corresponding to the training image and stores the ground truth image in the storage unit 101a. The ground truth image is an image obtained by performing image pickup simulation with shaped defocus blur being applied to the original image. The shape of the shaped defocus blur is, for example, bokeh equivalent to F2.0 or Gaussian blur equivalent to F1.0. The ground truth image and the training image may be undeveloped RAW images or developed images. The training image and the ground truth image may be generated in the opposite order. Double-line blur, bokeh, and Gaussian blur are will be described below with reference to FIG. 1. The upper diagram of FIG. 1 illustrates the PSF of double-line blur.

In the upper diagram of FIG. 1, the horizontal axis represents spatial coordinate (position), and the vertical axis represents intensity. This is the same for the middle diagram of FIG. 1 and the lower diagram of FIG. 1 to be described later. As illustrated in the upper diagram of FIG. 1, double-line blur has a PSF with separated peaks. In a case where the PSF at defocus distance has a shape as in the upper diagram of FIG. 1, an object that originally appears as a single line is doubly blurred when defocused. The middle diagram of FIG. 1 illustrates the PSF of bokeh. Bokeh has a PSF with flat intensity. The lower diagram of FIG. 1 illustrates the PSF of Gaussian blur. Gaussian blur has a PSF of Gaussian distribution.

At step S204, the calculation unit 101c applies noise to the ground truth image.

Each step of gradually adding noise is denoted as time t, and the final time is denoted as T. The noise added at each time t is Gaussian noise. In a case of T=1000, Gaussian noise is added 1000 times. In other words, a plurality of noise images with different noise amounts, and time data are generated for one ground truth image. A noise amount to be added at each time is determined by a noise scheduler. The noise scheduler is a parameter that controls a noise amount to be added at each time step. Examples of the noise scheduler include a linear scheduler and a cosine scheduler, but in the present example, the cosine scheduler is used. The above-described number steps of adding noise and the noise scheduler are not limited to the above description.

At step S205, the calculation unit 101c generates a model output based on the training image by using the machine learning model. The model output in defocus blur shaping in the present example has the configuration of a machine learning model illustrated in FIG. 10, but the present disclosure is not limited thereto. Input data to the machine learning model is a training image 203, a noise image 204 at time t, which is generated at step S204, and time data 205 indicating time t. The shape of the time data is not fixed but may be a scalar value or a two-dimensional map. A position where the time data is input to the neural network is not limited, and the time data may be input from the same position as the training image 203 or may be separately input from an intermediate layer.

At step S206, the update unit 101d updates the weights of the machine learning model based on an error function. In the present example, the error function is the error between a model output 206 and a ground truth model output. In a case where a noise image of time t is input, the ground truth model output is a noise image of time t−1. The error is calculated by using mean squared error (MSE). However, the error function is not limited thereto. The weights may be updated by using backpropagation or the like. The error may be calculated for a residual component. In the case of the residual component, the error between difference components between the model output 206 and the training image 203 and between the ground truth model output and the training image 203 is used.

At step S207, the update unit 101d determines whether the training of the machine learning model is completed. The completion can be determined based on, for example, whether the number of iterations of the weight update has reached a predetermined number or whether change amounts of the weights at the updating are smaller than a predetermined value. The update unit 101d ends the present flow when having determined that the training has completed, or executes the processing at step S201 when having determined otherwise. After the present flow is ended, information regarding the configuration and weights of the machine learning model is stored in the storage unit 101a.

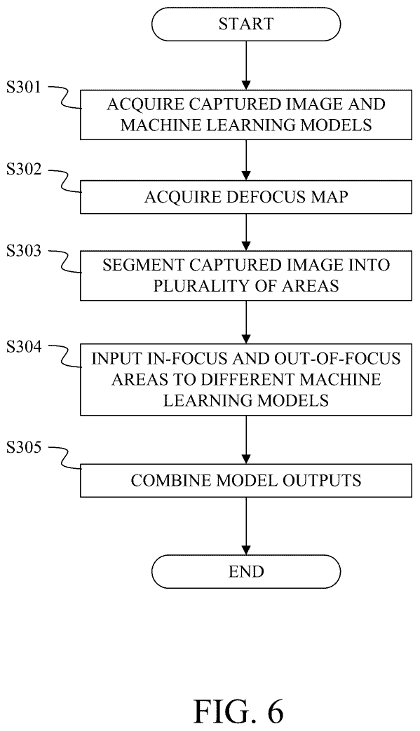

Blur sharpening on a focal plane and defocus blur shaping on a non-focal plane in a captured image by using a trained machine learning model, which are executed by the image processing apparatus 103 will be described below with reference to FIG. 6. The image processing apparatus 103 includes the storage unit 103a, an acquisition unit 103b, and a processing unit 103c, and each step below is executed by either member.

At step S301, the acquisition unit 103b acquires a captured image and a machine learning model. Information regarding the configuration and weights of the machine learning model is acquired from the storage unit 103a. In the present example, a CNN is used for blur sharpening on the focal plane and a diffusion model that is one of generative models is used for defocus blur shaping on the non-focal plane, and thus two machine learning models are acquired. The number of acquired machine learning models is not limited, and three or more machine learning models may be acquired.

At step S302, the acquisition unit 103b acquires distance information regarding the captured image. The distance information regarding the captured image is, for example, a depth map or a defocus map. The depth map is a map indicating information regarding the distance to an object in the captured image and numerically indicates the distance to the object. The depth map can be acquired by a distance measurement apparatus such as a ToF sensor. For example, in a case where pixel values range from 0 to 255, the distance to the object can be expressed by assigning values closer to 255 for greater distances and values closer to 0 for closer distances. Values closer to 0 may be assigned for greater distances to the object and values closer to 255 may be assigned for closer distances to the object, and the range of pixel values is not limited to from 0 to 255.

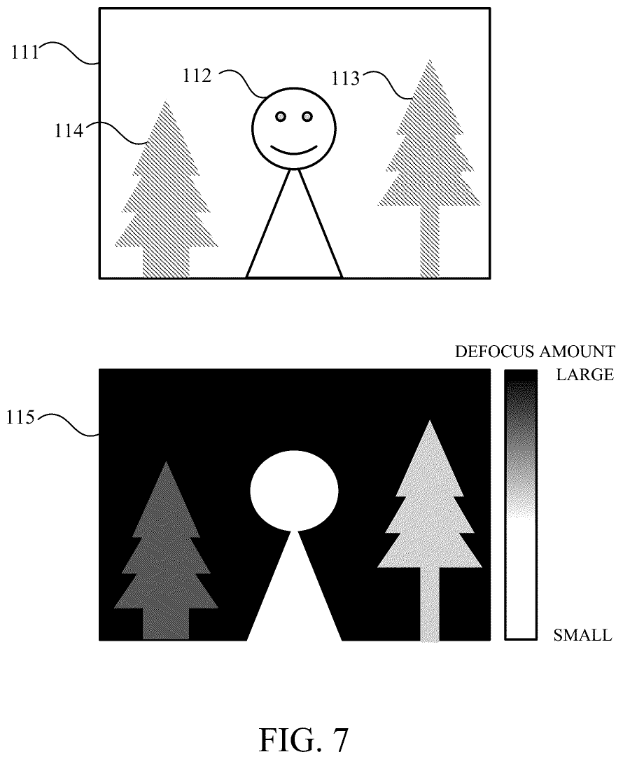

In a case where the depth map is used, information regarding which object is in focus is needed to specify an in-focus object in some cases. The information regarding which object is in focus can be acquired from, for example, focus information at image capturing. The defocus map is a map indicating information regarding defocus blur applied to an object in the captured image and numerically indicates the defocus amount of the object. The defocus map can be acquired by using image pickup of a parallax image, depth from defocus (DFD), or the like. For example, the focal plane may be set to 0, with the direction departing from an image pickup apparatus considered negative and the direction approaching the image pickup apparatus considered positive. In the present example, the defocus map is used as the distance information regarding the captured image. Maps related to the distance to the object are not limited to the depth map and the defocus map. The upper diagram of FIG. 7 illustrates a captured image 111, and the lower diagram of FIG. 7 illustrates a defocus map 115. An in-focus object 112, an out-of-focus object 113 (small defocus amount), and an out-of-focus object 114 (large defocus amount) exist, and the value of the defocus map varies in accordance with the defocus amount.

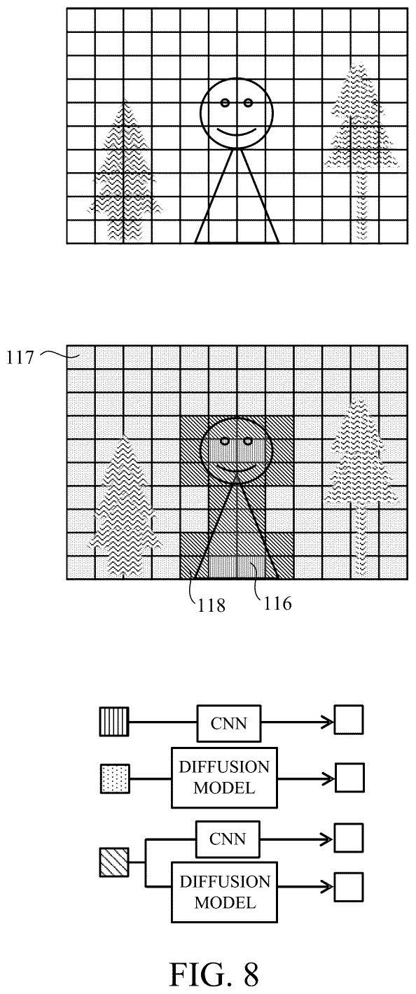

At step S303, the processing unit 103c segments the captured image into a plurality of areas. The upper diagram of FIG. 8 illustrates an example in which the captured image 111 is segmented. In the upper diagram of FIG. 8, the captured image is segmented into a total of 120 patches with 10 vertical segments and 12 horizontal segments, but the number of segments is not fixed. In a case where each patch is input to a machine learning model, surrounding pixels of the patch are affected by convolutional layers of the machine learning model, and thus the patch may include a range larger than an area intended to be processed. Adjacent patches are connected after the surrounding pixels affected by the convolutional layers are excluded from the output of the machine learning model, and accordingly, the entire captured image can be processed without being affected by the convolutional layers.

At step S304, the processing unit 103c inputs the captured image, which is segmented into the plurality of areas, to different machine learning models for in-focus and out-of-focus areas. The middle diagram of FIG. 8 illustrates an explanatory diagram of an input method. In the captured image segmented into the plurality of areas, an in-focus area 116 is input to the CNN, an out-of-focus area 117 is input to the diffusion model, and a boundary area 118 between an in-focus area and an out-of-focus area is input to both the CNN and the diffusion model. The defocus map acquired at step S302 is used to determine in-focus and out-of-focus areas. In the present step, in a case where the final time t is set to 1000 and noise addition is repeated 1000 times, forward propagation of the diffusion model is repeated 1000 times to gradually remove noise. The number of times of noise addition and the number of times of forward propagation do not necessarily need to be equal, and certain time points may be skipped. Accordingly, processing time can be reduced.

At step S305, the processing unit 103c combines model outputs based on the defocus map. The model output of the CNN is used for in-focus areas, the model output of the diffusion model is used for out-of-focus areas, and the model outputs of the CNN and the diffusion model are combined based on the defocus map for boundary areas between in-focus area and out-of-focus areas. In the defocus map acquired at step S301, the pixel value of an in-focus area in the image is 1, and the pixel value of an out-of-focus area in the image is 0. In the present example, the model outputs of the CNN and the diffusion model can be combined through weighted addition based on the defocus map. The combination method is not limited, and the combination may be performed by another method. For example, a defocus map that continuously changes from 0 to 1 in accordance with the defocus amount may be used, and the model outputs of the CNN and the diffusion model may be weighted and added with a ratio of 50% each in areas where the defocus amount is 0.5

As described above, with the configuration of the present example, it is possible to provide a highly accurate image processing method with reduced occurrence of artificial structures in image processing using machine learning models.

### Example 2

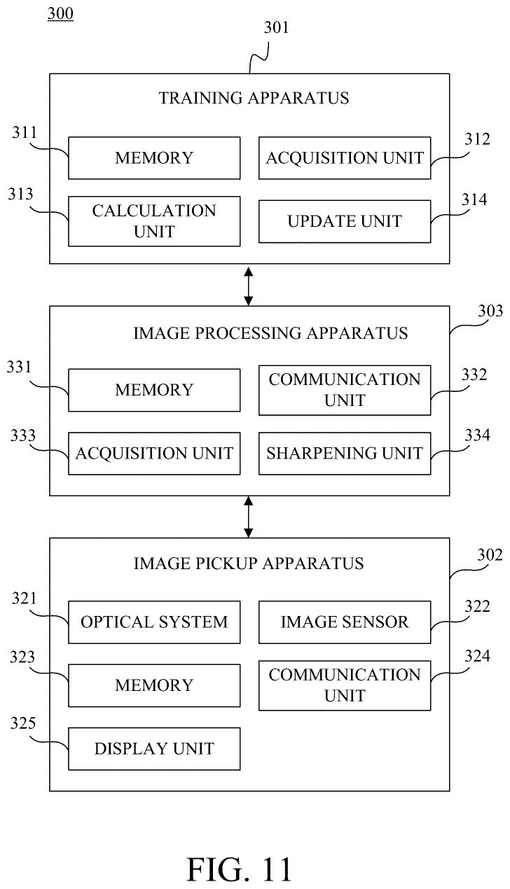

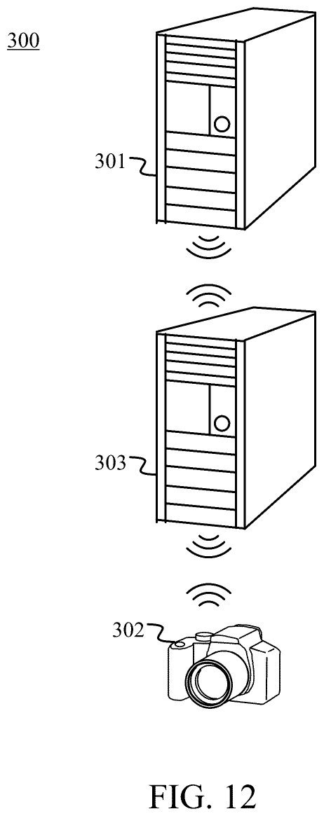

FIGS. 11 and 12 are a block diagram and an exterior diagram, respectively, of an image processing system 300 in the present example. The image processing system 300 includes a training apparatus 301, an image pickup apparatus 302, and an image processing apparatus 303. The training apparatus 301 and the image processing apparatus 303, as well as the image processing apparatus 303 and the image pickup apparatus 302, are each connected through a wired or wireless network. The image pickup apparatus 302 includes an optical system 321, an image sensor 322, a storage unit 323, a communication unit 324, and a display unit 325. A captured image is transmitted to the image processing apparatus 303 through the communication unit 324. The image processing apparatus 303 receives the captured image through a communication unit 332 and performs blur sharpening on a focal plane and defocus blur shaping on a non-focal plane in the captured image by using information regarding the configuration and weights of a machine learning model stored in a storage unit 331. The information regarding the configuration and weights of the machine learning model is trained by the training apparatus 301, acquired from the training apparatus 301, and stored in the storage unit 331 in advance. An image obtained through execution of blur sharpening on the focal plane and defocus blur shaping on the non-focal plane in the captured image is transmitted to the image pickup apparatus 302, stored in the storage unit 323, and displayed on the display unit 325.

Learning data generation and weight update (learning phase) performed by the training apparatus 301 are the same as in Example 1 and thus description thereof is omitted.

The image processing apparatus may be any apparatus having image processing functions in the present example and may be achieved in the form of an image pickup apparatus or a PC.

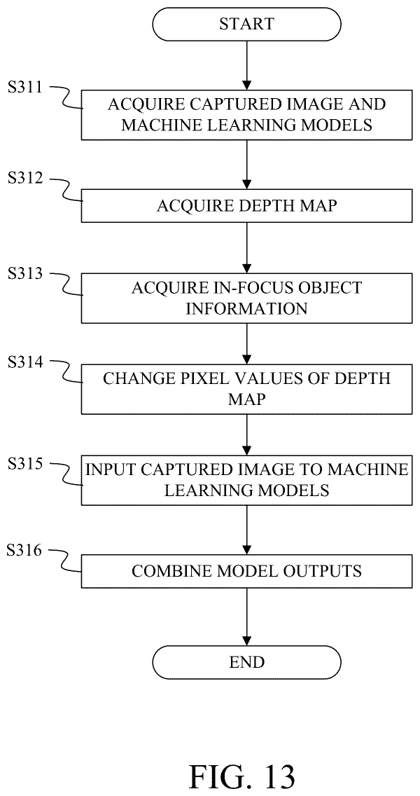

Blur sharpening on a focal plane and defocus blur shaping on a non-focal plane in a captured image by using a trained machine learning model, which are executed by the image processing apparatus 303 will be described below with reference to FIG. 13.

At step S311, an acquisition unit 333 acquires a captured image and machine learning models. Information regarding the configuration and weights of machine learning models is acquired from the storage unit 331. In the present example, a CNN is used for blur sharpening on the focal plane and a diffusion model that is one of generative models is used for defocus blur shaping on the non-focal plane, and thus two machine learning models are acquired.

At step S312, the acquisition unit 333 acquires distance information regarding the captured image. In the present example, the depth map is used as the distance information regarding the captured image. In the present example, pixel values of the depth map range from 0 to 1 and are set to be closer to 0 for greater distances to an object and closer to 1 for closer distances to the object. The setting method of the pixel values is not limited thereto, and the pixel values may be set to be closer to 0 for greater distances to the object and closer to 255 for closer distances to the object.

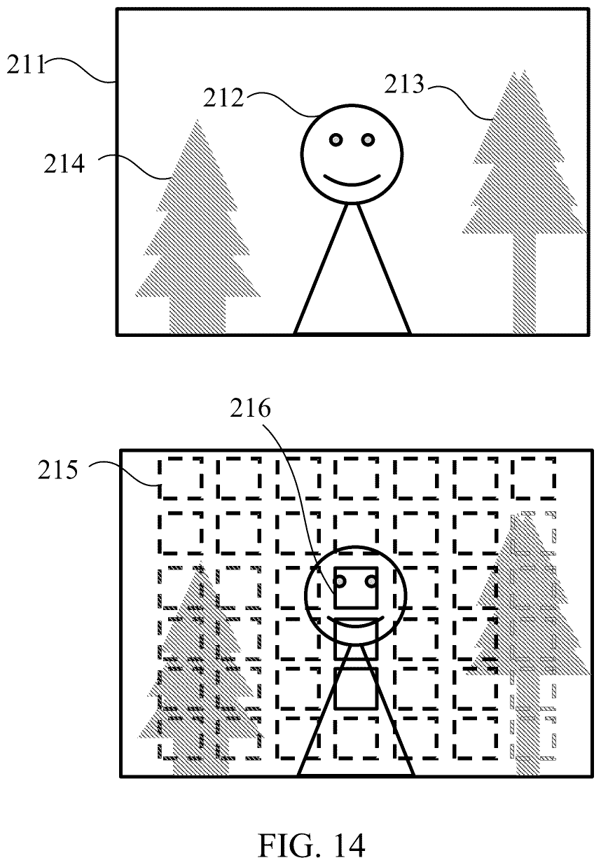

At step S313, the acquisition unit 333 acquires in-focus object information. The in-focus object information is information indicating which object is in focus in the captured image. In the present example, autofocus information recorded at image capturing is used as the in-focus object information. The upper diagram of FIG. 14 illustrates an example of the captured image, and the lower diagram of FIG. 14 illustrates an example of the autofocus information. This captured image 211 includes an in-focus object 212, an out-of-focus object 213 (background blur), and an out-of-focus object 214 (foreground blur). Each dotted line 215 represents an area that can be focused, and each solid line 216 represents an area that is focused. With this information, it is understood that the in-focus object 212 is in focus in the captured image 211. Areas that can be focused, which are illustrated in the lower diagram of FIG. 14 are exemplary and the present disclosure is not limited thereto.

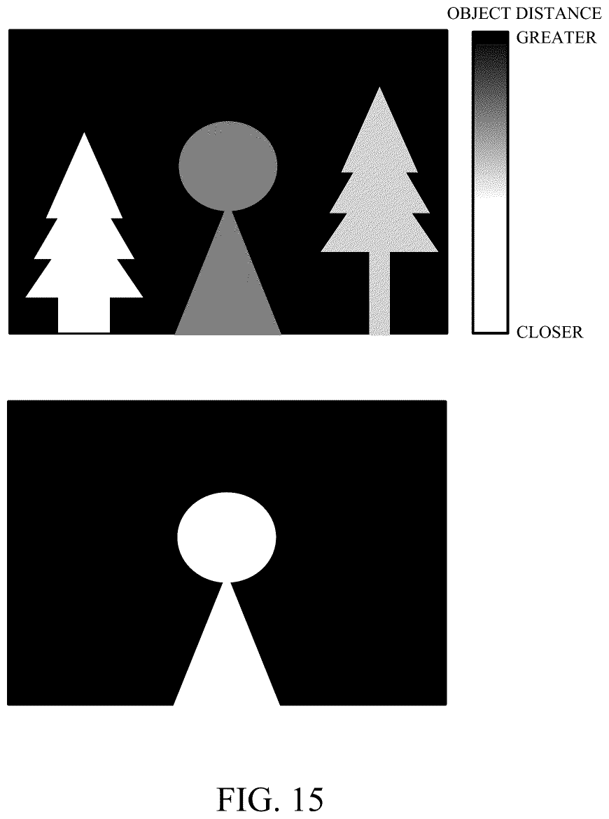

At step S314, a sharpening unit 334 changes the pixel values of the depth map based on the in-focus object information. The upper diagram of FIG. 15 illustrates the depth map acquired at step S312, and the lower diagram of FIG. 15 illustrates the depth map thus changed. In the present example, the pixel values of the depth map are changed such that the pixel value of an in-focus object area is 1 and the pixel value of an out-of-focus object area is 0.

At step S315, the sharpening unit 334 inputs the captured image to the machine learning models. In the present example, the entire captured image is input to both the CNN and the diffusion model, and their outputs are combined based on the depth map. The picked image may be segmented into a plurality of patches when input to the machine learning models. FIG. 16 explains the machine learning models in the present example. As in Example 1, input data 217 to the CNN in the present example is the captured image. Input data 218 to the diffusion model is the captured image, a noise image, and time data. Input data is not limited, and additional data may be input.

At step S316, the sharpening unit 334 generates a combined image 220 from the model outputs based on a depth map 219. The combined image 220 is combined by weighting and adding an output 221 of the CNN and an output 222 of the diffusion model, with the output 221 for the focal plane and the output 222 for the non-focal plane, by using the depth map acquired at step S314.

As described above, with the configuration of the present example, it is possible to provide a highly accurate image processing method with reduced occurrence of artificial structures in image processing using machine learning models.

### Example 3

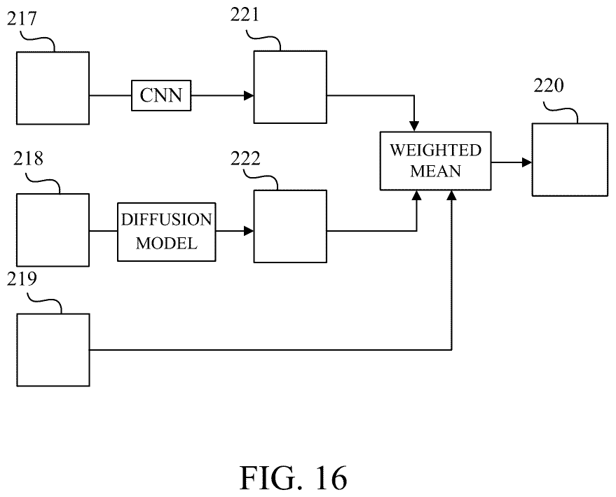

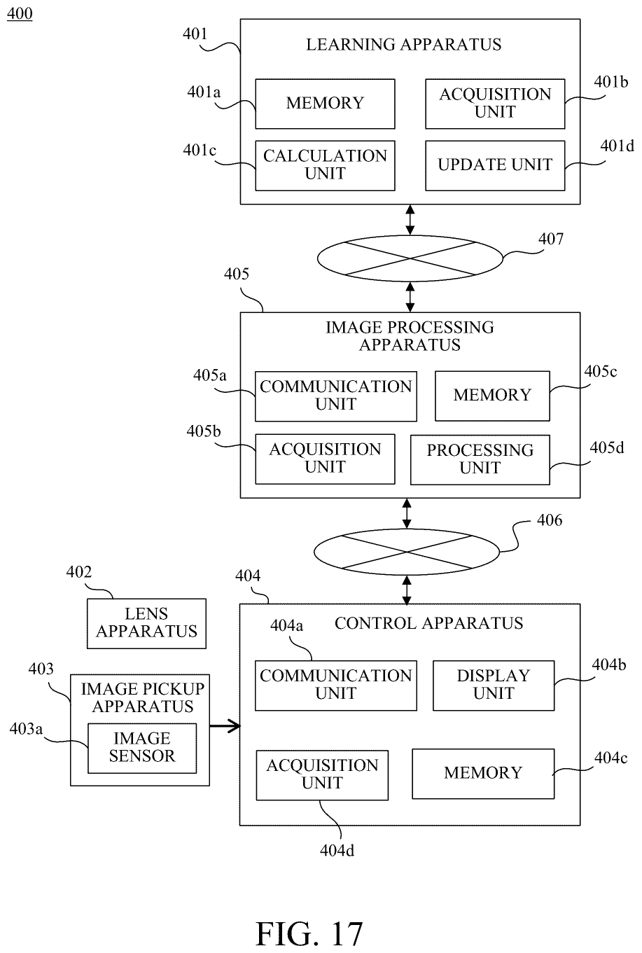

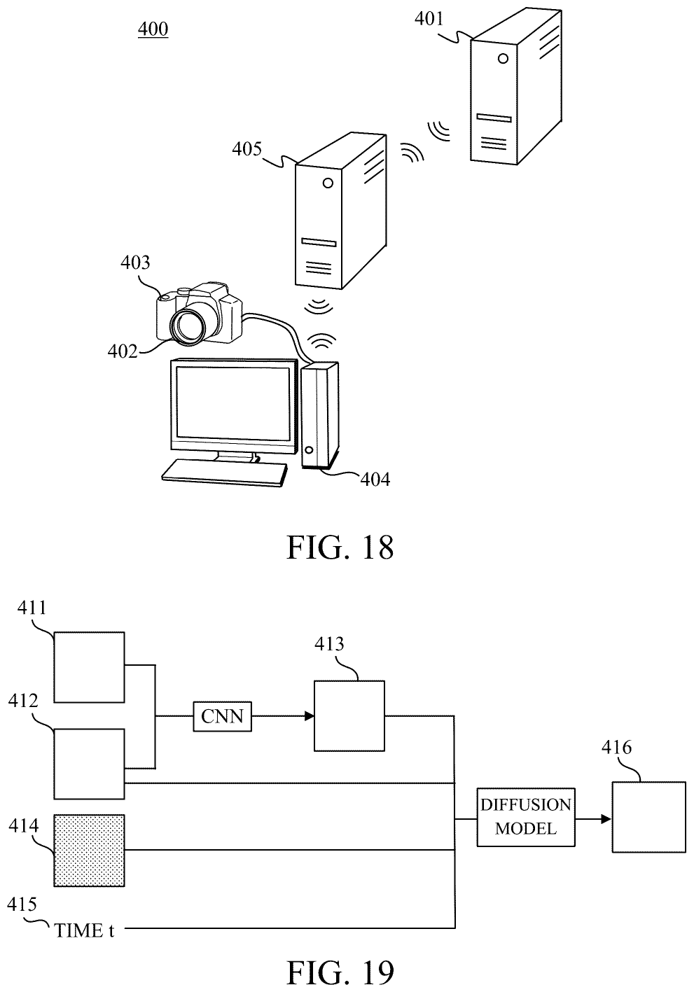

FIGS. 17 and 18 are a block diagram and an exterior diagram, respectively, of an image processing system 400 in the present example. The image processing system 400 includes a learning apparatus 401, a lens apparatus 402, an image pickup apparatus 403, a control apparatus (first apparatus) 404, an image processing apparatus (second apparatus) 405, and networks 406 and 407.

The learning apparatus 401 and an image processing apparatus 405 are, for example, servers. The control apparatus 404 is an instrument operated by a user, such as a personal computer or a mobile terminal. The learning apparatus 401 includes a storage unit 401a, an acquisition unit 401b, a calculation unit 401c, and an update unit 401d. The learning apparatus 401 updates weights of machine learning models that perform blur sharpening on a focal plane and defocus blur shaping on a non-focal plane in a captured image obtained through image picked-up using the lens apparatus 402 and the image pickup apparatus 403. The image pickup apparatus 403 includes an image sensor 403a and acquires a captured image as the image sensor 403a photoelectrically converts an optical image formed through the lens apparatus 402. The lens apparatus 402 and the image pickup apparatus 403 are detachably attached and can be each combined with a plurality of kinds.

The control apparatus 404 includes a communication unit 404a, a display unit 404b, a storage unit 404c, and an acquisition unit 404d and controls, in accordance with a user operation, processing to be executed on a captured image acquired from the image pickup apparatus 403 connected in a wired or wireless manner. Captured images obtained by the image pickup apparatus 403 may be stored in the storage unit 404c in advance and read. The image processing apparatus 405 includes a communication unit 405a, an acquisition unit 405b, a storage unit 405c, and a processing unit 405d. The image processing apparatus 405 executes blur sharpening on the focal plane and defocus blur shaping on the non-focal plane in the captured image in accordance with a request from the control apparatus 404 connected through the network 406. The image processing apparatus 405 acquires information regarding weights obtained by learning, from the learning apparatus 401 connected through the network 406, at estimation of blur sharpening on the focal plane and defocus blur shaping on the non-focal plane or in advance and uses the information for estimation of the captured image. An estimated image obtained through estimation of blur sharpening on the focal plane and defocus blur shaping on the non-focal plane is transmitted to the control apparatus 404, stored in the storage unit 404c, and displayed on the display unit 404b.

The image processing apparatus may be any apparatus having image processing functions in the present example and may be achieved in the form of an image pickup apparatus or a PC.

Weight update (learning phase) will be described below with reference to FIG. 19. FIG. 19 explains machine learning models in the present example. In the present example, a CNN is used for blur sharpening on the focal plane, and a diffusion model that is one of generative models is used for defocus blur shaping on the non-focal plane.

In the present example, a captured image 411 and a defocus map 412 are input to the CNN that is a first machine learning model, and a first estimated image 413 in which only blur on the focal plane is sharpened is generated. Subsequently, the first estimated image 413, the defocus map 412, a noise image 414, and time data 415 are inputs to the diffusion model that is a second machine learning model, and a second estimated image 416 in which only defocus blur on the non-focal plane is shaped is generated. By inputting the defocus map to the machine learning model, it is possible to highly accurately distinguish an in-focus object and defocus blur. When no defocus map is available, it is impossible to distinguish an in-focus object and defocus blur including high-frequency components, and it is difficult to sharpen blur on the focal plane with the CNN and shape defocus blur on the non-focal plane with the diffusion model.

Thus, in the present example, an image of defocus blur on the non-focal plane is included in learning data with which sharpening of blur on the focal plane is learned, and blur on the focal plane is included in learning data with which defocus blur shaping on the non-focal plane is learned. In the CNN that learns sharpening of blur on the focal plane based on the defocus map, learning is performed such that only blur on the focal plane is sharpened and defocus blur is directly output without processing. However, in the diffusion model that learns defocus blur shaping on the non-focal plane based on the defocus map, learning is performed such that only defocus blur is shaped and blur on the focal plane is directly output without processing. The other learning methods are the same as in Examples 1 and 2 and description thereof is omitted.

In the present example, an estimated image generated by using the CNN is input to the diffusion model, but this order may be inverted. In other words, an estimated image generated by using one of the CNN and the diffusion model may be input to the other.

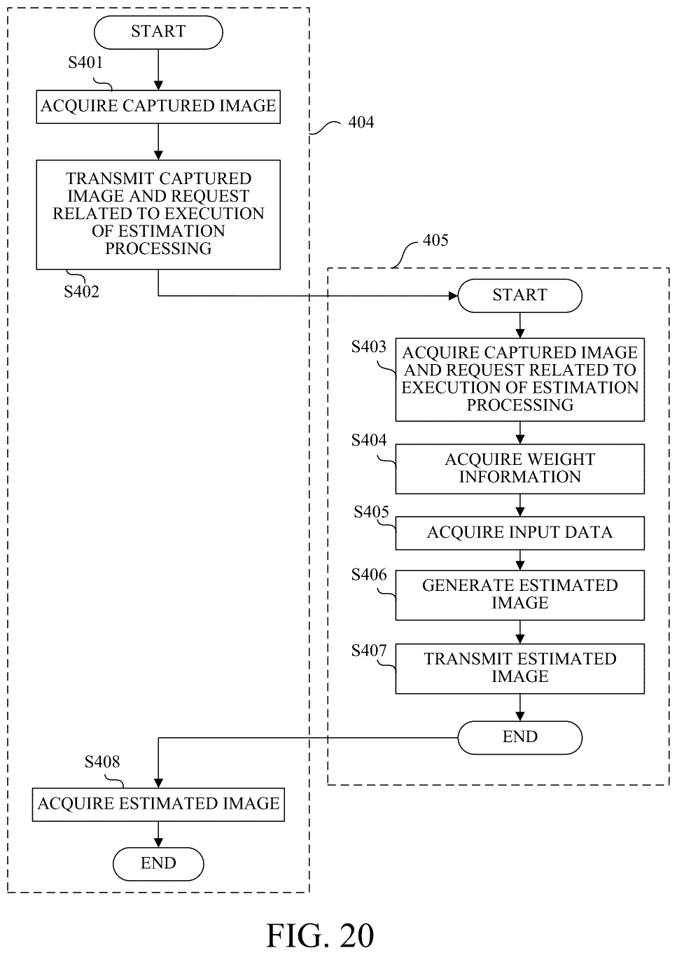

Blur sharpening on the focal plane and defocus blur shaping on the non-focal plane, which are executed by the control apparatus 404 and the image processing apparatus 405, will be described below with reference to FIG. 20. FIG. 20 is a flowchart illustrating model output generation in the present example.

At step S401, the acquisition unit 404d acquires a captured image.

At step S402, the communication unit 404a transmits the captured image and a request related to execution of estimation processing of blur sharpening to the image processing apparatus 405.

At step S403, the communication unit 405a receives and acquires the transmitted captured image and processing request.

At step S404, the acquisition unit 405b acquires information regarding learned weights corresponding to the captured image from the storage unit 405c. The weight information is read from the storage unit 401a and stored in the storage unit 405c in advance.

At step S405, the acquisition unit 405b acquires input data. The input data is a defocus map, a noise image, and time data.

At step S406, the processing unit 405d generates, from the captured image by using machine learning models, an estimated image (model output) in which blur sharpening on the focal plane and defocus blur shaping on the non-focal plane are executed.

At step S407, the communication unit 405a transmits the estimated image to the control apparatus 404.

At step S408, the communication unit 404a acquires the transmitted estimated image.

As described above, with the configuration of the present example, it is possible to provide a highly accurate image processing method with reduced occurrence of artificial structures in image processing using machine learning models.

In an image processing method in each example described below, the first machine learning model generates a first image by performing image estimation processing such as super-resolution, deblurring, or noise removal on input image. In training of a machine learning model that performs image estimation, the difference between an output image of the machine learning model and a desired ground truth image is expressed by a loss function such as mean square error (MSE). Model parameters (such as weights and biases of layers) of the machine learning model are determined by minimizing the value of the loss function. Typically, solution is not uniquely determined for input data in an image estimation task, and thus the value of the loss function does not reach zero even when the loss function is minimized, and a finite error remains. In the second machine learning model, this error (hereinafter referred to as a residual component) is generated and the residual component is weighted and added to the first image, and accordingly, an estimated image is generated. During estimation, the residual component added to the first image is referred to as an imparted component.

Consider a case where a generative model is applied to the second machine learning model. In particular, it is known that the diffusion model demonstrates higher performance than non-generative models in regression tasks such as deblurring, depth estimation, and super-resolution. However, while generative models can generate high-resolution textures, it is known that the models potentially generate unnatural structures that do not exist in the original object.

Thus, in the image processing method in each example, the second machine learning model only generates the residual component to reduce the occurrence of unnatural structures, and the residual component (first imparted component) is weighted and added (as a second imparted component) to the first image, which makes it possible to adjust weights of outputs of generative models, thereby acquiring a high-quality image.

In a case where authenticity in an estimated image is prioritized, the second machine learning model may be a generative model. By estimating only the residual component using the generative model, rather than generating the entire image using the generative model, it is possible to reduce the occurrence of unnatural structures and reduce degradation of image quality.

The characteristics of a diffusion model will be described below. The diffusion model is a model that generates a desired image by gradually removing (reducing) noise from a noise image, and has a diffusion process and a reverse diffusion process.

The diffusion process in the diffusion model is a process of producing a complete noise image by gradually adding noise to a ground truth image. When an image at time t is represented by xₜ, a noise image at time t is represented by εₜ, noise intensity at time t determined by a noise scheduler is represented byβₜ, and an image at time t−1 is represented by xₜ₋₁, noise addition at each time is performed in accordance with Expression (1) described below.

$${x}_{t} = \sqrt{1 - {β}_{t}} {x}_{t - 1} + \sqrt{{β}_{t}} {ε}_{t} \qquad ( 1 )$$

The reverse diffusion process in the diffusion model is a process that finally generates a noiseless image by gradually removing noise from a complete noise image. For example, a neural network may be used for the reverse diffusion process in the diffusion model.

Each step of gradually adding noise is denoted as time t, and the final time is denoted as T. The noise added at each time t is Gaussian noise. In a case of T=1000, Gaussian noise is added 1000 times. In other words, a plurality of noise images with different noise amounts, and time data are generated for one ground truth image.

A noise amount to be added at each time is determined by a noise scheduler. The noise scheduler is a parameter that controls a noise amount to be added at each time step. Examples of the noise scheduler include a linear scheduler and a cosine scheduler. The above-described number steps of adding noise and the noise scheduler are exemplary, and their configuration in each example is not limited to the above description.

### Example 4

The image processing system 100 in Example 4 will be described below.

The first machine learning model in the present example generates a model output by removing (reducing) noise from an input image. Moreover, a CNN that is one of non-generative models is used as the first machine learning model, but the structure of each machine learning model is not limited thereto. For example, a vision transformer (ViT) may be used as a non-generative model. Weights of imparted components are adjusted in accordance with the intensity of noise removal or the ISO sensitivity. The present example is not limited thereto, and the same effect is obtained for tasks other than noise removal (reduction). Examples of other tasks include correction of blur and aberration, as well as super-resolution (upsampling)

The diffusion model that is one of generative models is used as the second machine learning model in the present example, but the structure of each machine learning model is not limited thereto. For example, a VAE or a GAN may be used as generative model. Moreover, the first machine learning model may be a generative model and the second machine learning model may be a non-generative model.

FIG. 2 illustrates the configuration of the image processing system 100 in the present example. FIG. 3 illustrates the appearance of the image processing system 100. The configuration of the image processing system 100 in the present example is the same as in Example 1, and thus description thereof is omitted.

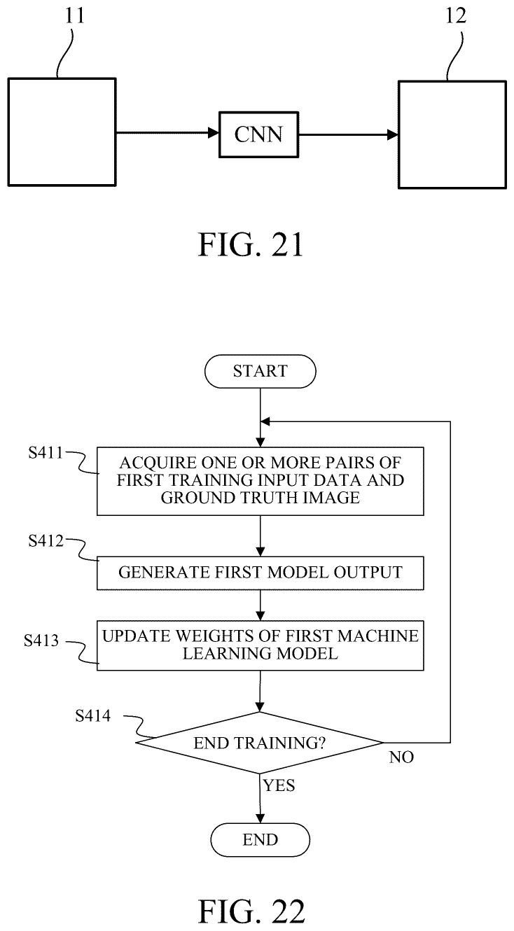

A method of training the first machine learning model (method of generating a learning-completed model), which is executed by the training apparatus 101 in the present example will be described below with reference to FIGS. 21 and 22. FIG. 21 is a conceptual diagram illustrating learning (training) of a machine learning model. FIG. 22 is a flowchart related to learning (training) of the first machine learning model. The first machine learning model in the present example is a CNN that performs image processing of removing (reducing) noise in an input image.

At step S411, the acquisition unit 101b acquires one or more pairs of first training input data and a ground truth image from the storage unit 101a.

In the present example, the first training input data is a high-noise image containing noise, and the ground truth image is a low-noise image in which the same object as in the high-noise image exists and noise is removed from the training input data. The first training input data may include other images and maps in addition to images containing noise and may include, for example, a map indicating the strength of noise. Pairs of a low-noise image and a high-noise image can be prepared by real-world image pickup, image pickup simulation, computer graphics (CG), or the like.

At step S412, the calculation unit 101c generates a first model output 12 by inputting the first training input data to the first machine learning model. The first model output 12 in the present example is a low-noise image obtained by reducing noise from a high-noise image.

The first machine learning model in the present example is a CNN that uses the convolution of an input and a filter as linear combination. The values of elements of the filter in the CNN correspond to weights. The sum with biases may be included. In each layer, nonlinear conversion using an activation function such as a rectified linear unit (ReLU) or a sigmoid function is executed as necessary. The first machine learning model may further include residual blocks and skip connections (also referred to as shortcut connections) as necessary.

At step S413, the update unit 101d updates the weights of the first machine learning model by using an error function. In the present example, an error function based on the error (loss) between the first model output 12 and the ground truth image is used. The error is calculated by using mean squared error (MSE). However, the error function is not limited thereto. For example, backpropagation can be used for weight update using the error function. The error may be calculated for a difference component from a high-noise image. In this case, the error between difference components between the first model output 12 and a high-noise image 11 and between the ground truth image and the high-noise image 11 is used.

At step S414, the update unit 101d determines whether the training of the first machine learning model is completed. The completion can be determined based on, for example, whether the number of iterations of the weight update has reached a predetermined number or whether change amounts of the weights at the updating are smaller than a predetermined value. In a case where it is determined at step S414 that the training is not completed, the present flow returns to step S411 and the acquisition unit 101b acquires one or more new pairs of the first training input data and the ground truth image. In a case where it is determined that the training is completed, the update unit 101d ends the training and stores information regarding the configuration and weights of the first machine learning model in the storage unit 101a.

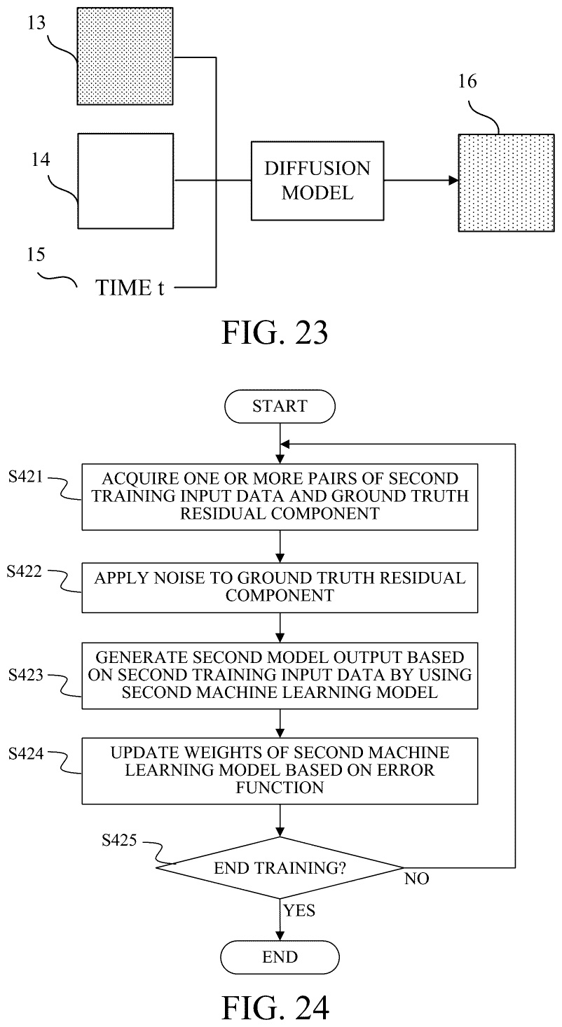

A method of training the second machine learning model (method of generating a learning-completed model), which is executed by the training apparatus 101 in the present example will be described below with reference to FIGS. 23 and 24. FIG. 23 is a conceptual diagram illustrating learning (training) of a machine learning model. FIG. 24 is a flowchart related to learning (training) of the second machine learning model. The second machine learning model in the present example is a diffusion model that performs image processing to generate the residual component.

At step S421, the acquisition unit 101b acquires one or more pairs of second training input data and a ground truth residual component from the storage unit 101a. The first training input data in the present example includes a high-noise image, and the output image of the first machine learning model is a low-noise image. With such a configuration, adverse effects of noise are likely to be reduced. The second training input data may include the output image of the trained first machine learning model. With such a configuration, the accuracy of image processing in an estimation step can be increased.

The output image of the first machine learning model being trained may be used as the second training input data, and moreover, the output image of the first machine learning model thus trained may be used. With such a configuration, a component generated by the second machine learning model (difference between the input image of the second machine learning model and the ground truth image) decreases in the output image of the trained first machine learning model, and accordingly, an estimated image with higher quality can be generated.

The methods of training the first machine learning model and the second machine learning model are not limited thereto. For example, the first machine learning model and the second machine learning model may be jointly trained or alternately trained. The ground truth residual component is a component (image) that is the difference between the output image of the first machine learning model and the corresponding ground truth image.

At step S422, the calculation unit 101c applies noise to the ground truth residual component. In the present example, a sine scheduler is used to determine a noise amount to be applied to the ground truth residual component at each time.

At step S423, the calculation unit 101c generates a second model output based on the second training input data by using the second machine learning model. The input data to the second machine learning model in the present example is second training input data 13, a noise image 14 at time t, which is generated at step S422, and time data 15 indicating time t. The shape of the time data may be a scalar value or a two-dimensional map. A position where the time data is input to the neural network is not limited and may be input from the same layer as the second training input data 13 or may be separately input to an intermediate layer.

At step S424, the update unit 101d updates the weights of the second machine learning model based on an error function. In the present example, an error function based on the error (loss) between a second model output 16 and the ground truth model output is used. In a case where a noise image at time t is input, the ground truth model output is a noise image at time t−1. The error is calculated by using mean squared error (MSE). However, the error function is not limited thereto. For example, backpropagation can be used for weight update using the error function.

At step S425, the update unit 101d determines whether the training of the second machine learning model is completed. The completion can be determined based on, for example, whether the number of iterations of the weight update has reached a predetermined number or whether change amounts of the weights at the updating are smaller than a predetermined value. In a case where it is determined at step S425 that the training is not completed, the present flow returns to step S421 and the acquisition unit 101b acquires one or more new pairs of the second training input data and a ground truth answer residual component image. In a case where it is determined that the training is completed, the update unit 101d ends the training and stores information regarding the configuration and weights of the second machine learning model in the storage unit 101a.

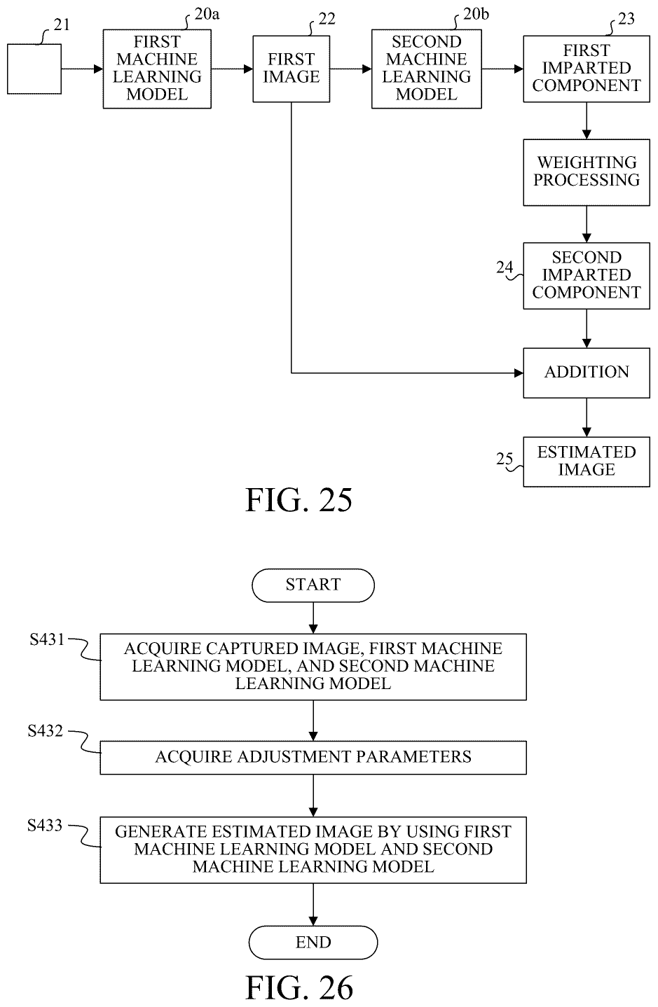

Estimated image generation using the trained first machine learning model and the trained second machine learning model, which is executed by the image processing apparatus 103 in the present example will be described below with reference to FIGS. 25 and 26. FIG. 25 is a conceptual diagram illustrating image processing using the first machine learning model and the second machine learning model. FIG. 26 is a flowchart related to the image processing using the first machine learning model and the second machine learning model.

At step S431, the acquisition unit 103b acquires a captured image, the first machine learning model, and the second machine learning model. Information regarding the configuration and weights of each machine learning model is acquired from the storage unit 103a. The captured image is an image obtained by image pickup with the image pickup apparatus 102 including an image pickup optical system (the optical system 102a). The captured image may be expressed in grayscale (image with a luminance component only) or may have channel components corresponding to a plurality of colors. In Example 1, since a CNN is used for noise removal of the captured image and a diffusion model that is one of generative models is used to generate the first imparted component, two machine learning models are acquired. The number of acquires machine learning models is not limited, and three or more machine learning models may be acquired and used to perform processing below.

At step S432, the acquisition unit 103b acquires adjustment parameters (weights). In the present example, information regarding ISO sensitivity associated with the captured image is acquired as information for determining the adjustment parameters, and the adjustment parameters are acquired based on the information regarding ISO sensitivity. The information regarding ISO sensitivity indicates ISO sensitivity that is set when the image pickup apparatus 102 picks up the captured image, and may be the value of ISO sensitivity itself or a value converted from the value of ISO sensitivity. The information for determining the adjustment parameters is not limited thereto. For example, the information may be information regarding noise removal intensity associated with the first machine learning model. The information regarding noise removal intensity indicates the intensity of noise removal executed by the first machine learning model and may be expressed in a scalar value or text information indicating a degree, such as “low”, “medium”, or “high”.

At step S433, the processing unit 103c generates an estimated image 25 based on a captured image 21 by using the first machine learning model, the second machine learning model, and the adjustment parameters.

First, the first machine learning model generates a low-noise image (first image) 22 based on the captured image 21 (input image).

Subsequently, the second machine learning model generates a first imparted component 23 based on the first image 22. An imparted component in the estimation step is equivalent to the residual component in the training step. At step S422, in a case where the final time is T=1000 (noise application is repeated 1000 times), the reverse diffusion process of the second machine learning model is repeated 1000 times to gradually remove noise, thereby generating the first imparted component 23. The number of times of noise addition and the number of reverse diffusion processes do not necessarily need to be equal, and certain time points may be skipped for processing time reduction.

Subsequently, the weight of the first imparted component 23 is determined based on information regarding the adjustment parameters. The value of a weight in the present example ranges from 0 to 1. For example, in a case where adjustment is performed based on the ISO sensitivity, high-frequency components are more likely to be lost in the first image 22 after noise removal as the ISO sensitivity is higher, and thus the weight of the imparted component is set closer to 1. In a case where adjustment is performed based on the noise removal intensity, high-frequency components are more likely to be lost as the value of the noise removal intensity is larger, and thus the weight of the imparted component is set closer to 1. In a case where information indicating the noise removal intensity is text information, the weight of the imparted component may be set closer to 1 as the noise removal intensity is higher.

Lastly, the sum of the weighted imparted component (second imparted component 24) and the first image 22 is taken to generate the estimated image 25.

In the present example, the estimated image 25 is generated by adding the weighted second imparted component 24 to the first image 22, but the method of generating the estimated image is not limited thereto in each example. For example, the first imparted component 23 may be generated through a number of reverse diffusion processes in accordance with information regarding the adjustment parameters and may be added to the first image 22. Alternatively, a plurality of first imparted components 23 may be generated based on information regarding the adjustment parameters, and the mean value of the plurality of first imparted components 23 may be calculated and added as the second imparted component 24 to the first image 22. As a modification, the first image 22 may be weighted with the adjustment parameters to generate a second image, and the second image and the first imparted component 23 may be added to generate the estimated image.

With the above-described configuration, it is possible to provide an image processing method or the like capable of generating a high-quality image by using a plurality of machine learning models.

### Example 5

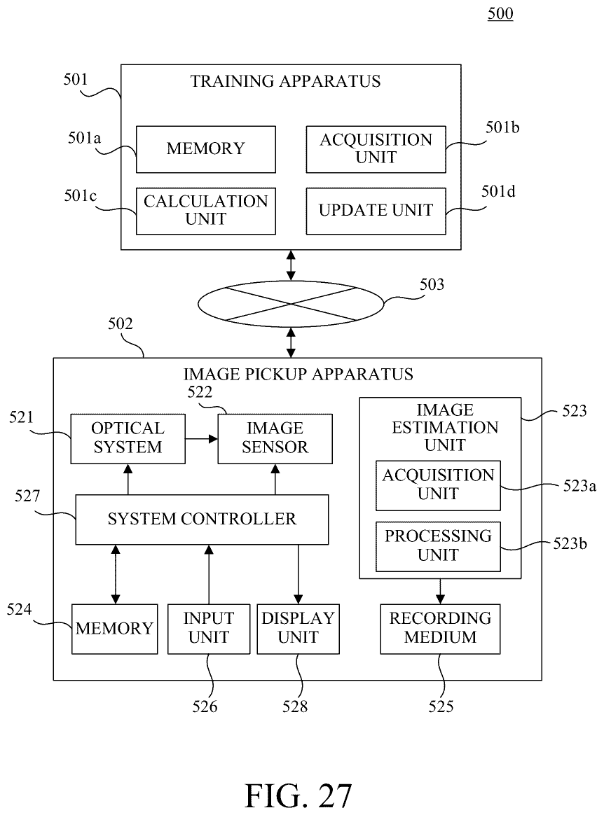

An image processing system 500 in Example 5 will be described below with reference to FIG. 27. FIG. 27 is a block diagram of the image processing system 500 in the present example. The image processing system 500 includes a training apparatus 501 and an image pickup apparatus 502. The configuration of the training apparatus 501 in the present example is the same as that of the training apparatus in Example 4.

The image pickup apparatus 502 in the present example executes deblurring of an input image by using machine learning models. In the present example, the weight of the first imparted component is adjusted in accordance with at least one of image pickup conditions, correction conditions of a first machine learning model 20a, optical characteristics, and image characteristics.

The image pickup apparatus 502 includes an optical system 521, an image sensor 522, an image estimation unit 523, a storage unit 524, a recording medium 525, a display unit 528, an input unit 526, and a system controller 527. The image pickup apparatus 502 acquires a captured image through image pickup of an object space and generates an estimated image. An optical system 521 and the image sensor 522 in the image pickup apparatus 502 are the same as in Example 4, and thus description thereof is omitted. The image pickup apparatus 502 reads information regarding the weights of the trained first machine learning model 20a and a trained second machine learning model 20b from the training apparatus 501 through a network 503 and stores the information in the storage unit 524.

The image estimation unit 523 includes an acquisition unit 523a and a processing unit 523b. The acquisition unit 523a acquires a captured image or the like. The processing unit 523b is the same as the processing unit 103c in Example 4. The captured image acquired by the acquisition unit 523a is provided with image processing based on weight information stored in the storage unit 524 to generate an estimated image.

The recording medium 525 stores the estimated image. In a case where an instruction related to display of the estimated image is provided from a user through the input unit 526, a stored output image is read and displayed on the display unit 528. The image estimation unit 523 may be read a captured image stored in the recording medium 525 when performing processing of generating the estimated image. The system controller 527 controls processing performed by the image pickup apparatus 502.

The image estimation unit 523 executes deblurring processing using the first machine learning model 20a on an input image to generate the first image 22, and generates the first imparted component 23 by using the second machine learning model 20b. The image estimation unit 523 in the present example determines weights based on the intensity of deblurring or image pickup conditions (information regarding the adjustment parameters) and takes the sum of the second imparted component 24 and the first image 22 generated by the weighting, thereby generating the estimated image 25.

The image pickup conditions are, for example, information indicating the ISO sensitivity, the focal length of the optical system 521, the aperture value, or the object distance, which are set when the image pickup apparatus 502 performs image pickup.

The optical characteristics are characteristics based on the optical system 521 and obtained based on a point spread function function (PSF) and an optical transfer function (OTF). The optical characteristics in the present example only need to indicate image blur due to aberrations and diffraction of the optical system. The optical characteristics may be, for example, a modulation transfer function (MTF) that is the amplitude component of the OTF, or a phase transfer function (PTF) that is the phase component of the OTF.

The correction conditions are information indicating he intensity of deblurring executed by the first machine learning model 20a. In a case where processing executed by the first machine learning model 20a is super-resolution, the correction conditions may indicate the magnification for super-resolution or the intensity of super-resolution.

The image characteristics are determined based on the size of blur or shake included in a captured image. The size of blur can be obtained by estimating the PSF. The size of shake can be obtained by, for example, a non-illustrated acceleration sensor included in the image pickup apparatus 502.

A method of training the first machine learning model 20a, which is executed by the training apparatus 501 in the present example will be described below with reference to FIG. 22 as in Example 4. The first machine learning model 20a in the present example is a CNN that ground truths image blur. The first training input data includes a blurred image in which blur due to the optical characteristics of the optical system 102a is applied, and the ground truth image is an image with less blur than the blurred image.

The first machine learning model 20a is not limited to a CNN that ground truths image blur but may be a model that performs image super-resolution. In this case, the first training input data includes a low-resolution image, and the ground truth image is a high-resolution image in which the same object as in the low-resolution image exists.

Processing (steps S411 to S414) by the training apparatus 501 is the same as processing using the training apparatus 101 in Example 4, and thus description thereof is omitted.

A method of training the second machine learning model 20b, which is executed by the training apparatus 501 in the present example will be described below with reference to FIG. 24 as in Example 4. The second machine learning model 20b in the present example is a diffusion model that learns generation of the first imparted component.

The second training input data in the present example is identical to the first training input data. At step S421, the acquisition unit 101b acquires one or more pairs of the second training input data and the ground truth answer residual component image from the storage unit 101a. With such a configuration, the second machine learning model 20b can be trained irrespective of processing of the first machine learning model 20a even when adverse effects have occurred due to false estimation or the like in processing of the first machine learning model 20a. The ground truth residual component in the present example is an image that is the difference between the output image of the first machine learning model 20a and the corresponding ground truth image.

Processing (steps S422 to S425) by the training apparatus 501 is the same as processing using the training apparatus 101 in Example 4, and thus description thereof is omitted.

Image processing in the present example uses the first machine learning model 20a that is a non-generative model and the second machine learning model 20b that is a generative model. The first image 22 is generated from the captured image 21 by the first machine learning model 20a, and the first imparted component is generated from the first image 22 (or the captured image 21) by the second machine learning model 20b. Then, the estimated image 25 is generated based on the first image 22, the first imparted component, and the adjustment parameters. Since only the first imparted component (residual component) is generated by the second machine learning model 20b that is a generative model, the occurrence of unnatural structures due to generative models can be reduced. As a result, an image processing method or the like capable of generating a high-quality image can be provided.

### Example 6

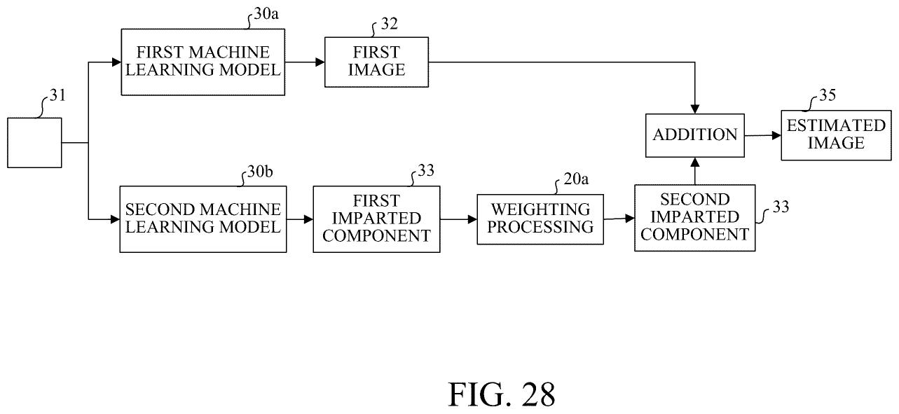

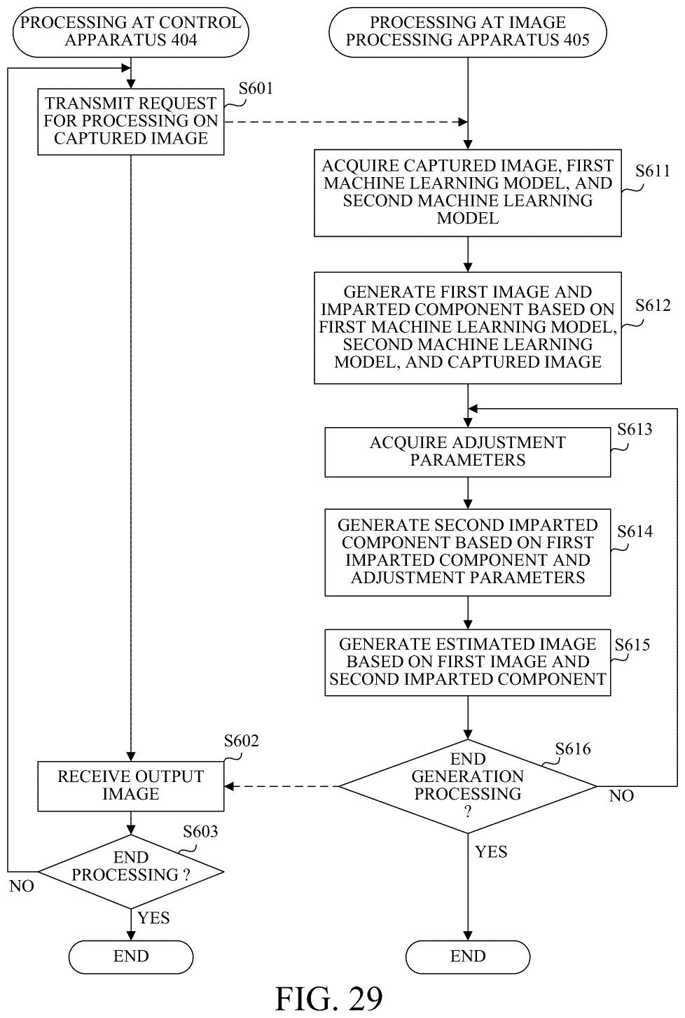

Estimated image generation using a trained first machine learning model 30a and a trained second machine learning model 30b, which is executed by the image processing apparatus 405 in the present example will be described below with reference to FIGS. 17, 28, and 29. FIG. 28 is a flowchart related to image processing using the first machine learning model 30a and the second machine learning model 30b. FIG. 29 is a flowchart related to the image processing using the first machine learning model 30a and the second machine learning model 30b. FIG. 17 is the same as in Example 3, and thus detailed description thereof is omitted.

In the present example, the first machine learning model 30a performs processing that ground truths blur of a captured image, and the second machine learning model 30b generates a first imparted component 33. An estimated image is generated based on the adjustment parameters (weights). The first imparted component 33 corresponds to the residual component in training.

The example in which the weight of the first imparted component 33 is determined based on each condition is described above in Examples 4 and 5, but in the present example, the adjustment parameters (weights) are determined based on a value (information regarding the adjustment parameters) designated by the user. In this case, the user can change the designated value while checking an estimated image result generated on the display apparatus 104.

Operation of the control apparatus 404 will be described first. The image processing in the present example is started by an image processing start instruction by the user through the control apparatus 404.

At step S601 (first transmission step), the communication unit 405a transmits a request for processing on the captured image to the image processing apparatus 303. At step S601, the control apparatus 404 may transmit an ID that authenticates the user, image capturing conditions corresponding to the captured image, and the like together with the request for processing on the captured image.

At step S602 (first reception step), the communication unit 405a receives an output image generated by an image processing apparatus 405.

At step S603, the control apparatus 404 checks reception of an estimated image and determines whether to end the processing. In this case, the processing may be ended upon an operation by the user. For example, in a case where information regarding the adjustment parameters of different values is input from the user after step S604 to be described later, the present flow returns to step S603 and the acquisition unit 405b acquires new values designated by the user. In a case where there is no value redesignation by the user after step S604, the process may proceed to step S603 to end the estimated image generation processing.

Operation of the image processing apparatus 405 will be described below. A communication unit 303f receives a request for processing on a captured image 31 transmitted from the communication unit 405a. Upon reception of an instruction for processing on the captured image, an image processing apparatus 603 executes processing at step S601 and later.

At step S611, the acquisition unit 405b acquires the first machine learning model 30a (or its weight information), the second machine learning model 30b (or its weight information), and the captured image 31. In the present example, the captured image 31 is transmitted from the control apparatus 404. In this case, image capturing conditions corresponding to the captured image 31 may be acquired together with the captured image 31.

At step S612, the processing unit 405d generates a first image 32 by using the first machine learning model 30a and generates the first imparted component 33 by using the second machine learning model 30b. The reverse diffusion process of the diffusion model in generation of the first imparted component 33 is the same as in Example 4.

At step S613, an acquisition unit 303b acquires information regarding the adjustment parameters. In the present example, a value designated by the user are acquired. The user can designate the value through, for example, a non-illustrated input unit of the control apparatus 404. The adjustment parameters may be the value designated by the user or may be its converted value. For example, the value designated by the user may be converted into a value of 0 to 1, and the converted value may be applied as a weight to the imparted component.

At step S614, the processing unit 405d generates a second imparted component 34 based on the first imparted component 33 and its weight.

At step S615, an estimated image 35 is generated based on the first image 32 and the second imparted component 34. In the present example, the estimated image 35 is generated by taking the sum of the first image 32 and the second imparted component 34.

At step S616, the processing unit 405d determines whether to end the processing of generating the estimated image 35. The processing unit 405d determines whether to end the processing by, for example, converting blur and adverse effect amounts of the estimated image 35 into parameters and comparing the parameters with threshold values. The processing unit 405d may display the generated estimated image 35 to the user and determine to end the processing in a case where the adjustment parameters are not re-entered by the user.

In a case where the first machine learning model 30a performs deblurring, the adjustment parameters may be determined based on information indicating the focal length, aperture stop, and object distance of the optical system 102a, which are set at image pickup of the captured image, and the optical characteristics of an optical system in the lens apparatus 402. In this case, the weight of the first imparted component may be set closer to 1 as the diameter of the PSF determined by the image pickup conditions and the optical characteristics is larger. Similarly, in a case where adjustment is performed based on the image characteristics, the weight of the imparted component may be set closer to 1 as the PSF of estimated shake is larger.

With the above-described configuration, it is possible to provide an image processing method or the like capable of generating a high-quality image by using two machine learning models.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

Each example can provide a highly accurate image processing method with reduced occurrence of artificial structures in image processing using machine learning models.

While the disclosure has described example embodiments, it is to be understood that the disclosure is not limited to the example embodiments. The scope of the following claims is to be accorded the broadest interpretation so as to encompass all such modifications and equivalent structures and functions.

This application claims the benefit of Japanese Patent Application No. 2024-010400, filed on Jan. 26, 2024, Japanese Patent Application No. 2024-050589, filed on Mar. 26, 2024 and Patent Application No. 2025-007096, filed on Jan. 17, 2025, each of which is hereby incorporated by reference herein in their entirety.

What is claimed is:

1. An image processing method comprising:
a step of generating an estimated image from an input image by using a plurality of machine learning models including a generative model and a non-generative model,
wherein, in the step, the estimated image is generated by assigning different weights to output of the generative model and output of the non-generative model for each of a plurality of areas of the input image based on information regarding the input image.

2. The image processing method according to claim 1, wherein the information regarding the input image includes at least one of distance information regarding the input image, a segmentation map, information regarding a saturated area, and an optical performance map.

3. The image processing method according to claim 2, wherein the distance information regarding the input image is a defocus map or a depth map.

4. The image processing method according to claim 1,
wherein the information regarding the input image includes distance information regarding the input image, and
wherein the estimated image is
generated with the weight of output of the non-generative model being greater than the weight of output of the generative model for an area determined to be an in-focus area among the plurality of areas based on the distance information regarding the input image, and
generated with the weight of output of the generative model being larger than the weight of output of the non-generative model for an area determined to be an out-of-focus area among the plurality of areas based on the distance information regarding the input image.

5. The image processing method according to claim 1,
wherein the information regarding the input image includes a segmentation map, and
wherein the estimated image is
generated with the weight of output of the non-generative model being larger than the weight of output of the generative model for an area determined to be an area including a person among the plurality of areas based on the segmentation map, and
generated with the weight of output of the generative model being larger than the weight of output of the non-generative model for an area determined to be an area including no person among the plurality of areas based on the segmentation map.

6. The image processing method according to claim 1, wherein the estimated image is
generated by using output of the non-generative model for an area determined to be a first area among the plurality of areas based on information regarding the input image, and
generated by using an output of the generative model for an area determined to be a second area among the plurality of areas based on information regarding the input image.

7. The image processing method according to claim 1, wherein, in the step, the estimated image is generated by weighted-averaging a first image and a second image based on information regarding the input image, the first image being generated by inputting the input image to the generative model, the second image being generated by inputting the input image to the non-generative model.

8. The image processing method according to claim 1, wherein, in the step,
a first image is generated by inputting the input image and the information regarding the input image to one of the generative model and the non-generative model, and
the estimated image is generated by inputting the first image and the information regarding the input image to the other of the generative model and the non-generative model.

9. The image processing method according to claim 1, wherein the estimated image is an image having a defocus blur with a shape different from a shape of a defocus blur of the input image.

10. A computer-readable storage medium storing a computer program that causes a computer to execute the image processing method according to claim 1.

11. An image processing method comprising:
generating a first image based on an input image by using a first machine learning model;
generating a first imparted component based on the input image or the first image by using a second machine learning model;
acquiring an adjustment parameter related to the first imparted component;
generating a second imparted component based on the first imparted component and the adjustment parameter; and
generating an estimated image based on the first image and the second imparted component.

12. An image processing method comprising:
generating a first image based on an input image by using a first machine learning model;
generating a first imparted component based on the input image or the first image by using a second machine learning model;
acquiring an adjustment parameter related to the first image;
generating a second image based on the first image and the adjustment parameter; and
generating an estimated image based on the second image and the first imparted component.

13. The image processing method according to claim 11, wherein the estimated image is generated by taking a sum of the second imparted component and the first image.

14. The image processing method according to claim 11
wherein the second machine learning model generates two or more first imparted components based on the adjustment parameter, and
wherein the second imparted component is an mean value of the two or more first imparted components.

15. The image processing method according to claim 11, wherein the adjustment parameter is a value determined based on at least one of image capturing condition, a correction condition of the first machine learning model, optical characteristics, and image characteristics.

16. The image processing method according to claim 15, wherein the image capturing condition is ISO sensitivity.

17. The image processing method according to claim 15, wherein the image capturing condition is at least one of a focal length, an aperture value, and an object distance.

18. The image processing method according to claim 15, wherein the correction condition is magnification for super-resolution, intensity of super-resolution, intensity of deblurring, and intensity of noise removal.

19. The image processing method according to claim 15, wherein the optical characteristics are characteristics of an optical system used to acquire the input image.

20. The image processing method according to claim 15, wherein the image characteristics are determined based on a size of a shake included in an input image.

21. The image processing method according to claim 11, wherein the second machine learning model generates the first imparted component in a number of reverse diffusion processes in accordance with the adjustment parameter.

22. The image processing method according to claim 11, wherein the second machine learning model is trained by using output of the first machine learning model.

23. An image processing method comprising:
generating a first image based on an input image by using a first machine learning model that is a non-generative model;
generating a first imparted component based on the input image or the first image by using a second machine learning model that is a generative model;
acquiring an adjustment parameter; and
generating an estimated image based on the first image, the first imparted component, and the adjustment parameter.

24. A computer-readable storage medium storing a computer program that causes a computer to execute the image processing method according to claim 11.
